(19) United States
(12) Patent Application Publication
(10) Pub. No.: US 2025/0292644 A1
(43) Pub. Date: Sep. 18, 2025

(54) FOOD COOKING AND VENDING DEVICE AND METHOD THEREOF

(71) Applicant: HCL Technologies Limited, Delhi (IN)

(72) Inventors: Charandeep Kapoor, Bangalore (IN); Rohit Surekh, Bangalore (IN); Sagar Chirankar, Bangalore (IN)

(21) Appl. No.: 19/000,753

(22) Filed: Dec. 24, 2024

(30) Foreign Application Priority Data
Mar. 12, 2024 (IN) 202411017771

(51) Int. Cl. G07F 17/00; G07F 9/00; G07F 11/72

(52) U.S. Cl. CPC G07F 17/0085; G07F 9/006; G07F 11/72

(57) ABSTRACT

This disclosure relates to food cooking and vending device and method thereof. The food cooking and vending device includes dispensing unit, conveyor belt, and control unit. The control unit receives a first user input through a User Interface (UI), wherein the first user input comprises non-confidential user details; generates one or more meal recommendations from a plurality of meal options based on the first user input using an Artificial Intelligence (AI) model; renders the one or more meal recommendations and remaining of the plurality of meal options to the UI; receives a second user input through the UI, wherein the second user input comprises a meal selection from the plurality of meal options; and causes the bowl dispensing section to dispense the bowl to the conveyor belt to initiate the meal preparation.

### DESCRIPTION

### Technical Field

This disclosure relates generally to the field of vending devices, and more particularly to a food cooking and vending device and method thereof.

### Background

Outside of home, people are faced with limited choices when it comes to healthy food options. For example, commuters, people working in office spaces, and visitors in public places (like shopping complexes, parks, theatres, etc.) often find it difficult to have healthy food options. Choices offered by a local vendor or a conventional vending machine are generally limited to packed unhealthy snacks. Hygiene levels and nutritional levels of such snacks are a cause of concern. On the other hand, conventional cooking methods are time-consuming, require dedicated personnel, and are less suitable for on-the-go or time-sensitive situations (such as upcoming departure of flight, starting of movie show at a cinema hall, limited time window between office meetings, etc.).

In the present state of art, vending machines capable of meal preparation are not context-aware and lack a sense of time-sensitivity for people in certain situations (for example, travelling passengers at airports, railway stations, etc., or people at office). Such machines do not consider urgency and specific requirements of the people when preparing meals. There is, therefore, a need in the present state of art for end-to-end automated food cooking and vending machines that address the above-mentioned issues.

### SUMMARY

In one embodiment, a food cooking and vending device is disclosed. In one example, the food cooking and vending device includes a dispensing unit. The dispensing unit includes a bowl dispensing section configured to dispense a bowl from a bowl storage section. The dispensing unit further includes a plurality of raw food material dispensing sections configured to dispense a plurality of raw food materials. The food cooking and vending device further includes a conveyor belt positioned below the dispensing unit. The conveyer belt is configured to move horizontally under the dispensing unit. The food cooking and vending device further includes a control unit. The control unit is configured to receive a first user input through a User Interface (UI). The first user input includes non-confidential user details. The control unit is further configured to generate one or more meal recommendations from a plurality of meal options based on the first user input using an Artificial Intelligence (AI) model. The control unit is further configured to render the one or more meal recommendations and remaining of the plurality of meal options to the UI. The control unit is further configured to receive a second user input through the UI. The second user input includes a meal selection from the plurality of meal options. The meal selection requires one or more raw food materials from the plurality of raw food materials for meal preparation. The control unit is further configured to cause the bowl dispensing section to dispense the bowl to the conveyor belt to initiate the meal preparation. For each of one or more raw material dispensing sections corresponding to the one or more raw food materials, the control unit is further configured to cause the conveyor belt to move the bowl to a location under a raw food material dispensing section. The control unit is further configured to cause the conveyor belt to stop under the raw food material dispensing section for a predefined time period. The control unit is further configured to cause the raw material dispensing section to dispense a raw food material into the bowl.

In one embodiment, a method of food cooking and vending is disclosed. In one example, the method includes receiving, by a control unit, a first user input through a User Interface (UI). The first user input includes non-confidential user details. The method further includes generating, by the control unit, one or more meal recommendations from a plurality of meal options based on the first user input using an Artificial Intelligence (AI) model. The method further includes rendering by the control unit, the one or more meal recommendations and remaining of the plurality of meal options to the UI. The method further includes receiving by the control unit, a second user input through the UI. The second user input includes a meal selection from the plurality of meal options. The meal selection requires one or more raw food materials from a plurality of raw food materials for meal preparation. The method further includes causing, by the control unit, a bowl dispensing section to dispense a bowl to a conveyor belt to initiate the meal preparation. A dispensing unit includes the bowl dispensing section and a plurality of raw food material dispensing sections. The bowl dispensing section is configured to dispense a bowl from a bowl storage section. A plurality of raw food material dispensing sections is configured to dispense the plurality of raw food materials. A conveyor belt is positioned below the dispensing unit. The conveyer belt is configured to move horizontally under the dispensing unit. For each of one or more raw food material dispensing sections corresponding to the one or more raw food materials, the method further includes causing, by the control unit, the conveyor belt to move the bowl to a location under a raw food material dispensing section. The method further includes causing, by the control unit, the conveyor belt to stop under the raw food material dispensing section for a predefined time period. The method further includes causing, by the control unit, the raw food material dispensing section to dispense a raw food material into the bowl.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1A illustrates an internal view (rear side) of a food cooking and vending device, in accordance with some embodiments.

FIG. 1B illustrates an external view (front side) of a food cooking and vending device, in accordance with some embodiments.

FIG. 2 illustrates a functional block diagram of a control unit of an exemplary food cooking and vending device, in accordance with some embodiments.

FIG. 3 illustrates a flowchart of an exemplary method of cooking and vending food, in accordance with some embodiments.

FIG. 4 illustrates a flowchart of an exemplary method for generating meal recommendations by a food cooking and vending device, in accordance with some embodiments.

FIG. 5 illustrates a flowchart of an exemplary method of meal preparation by a food cooking and vending device, in accordance with some embodiments.

FIG. 6 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

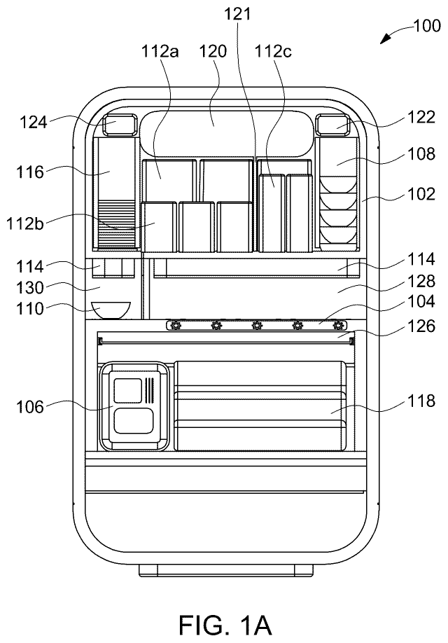

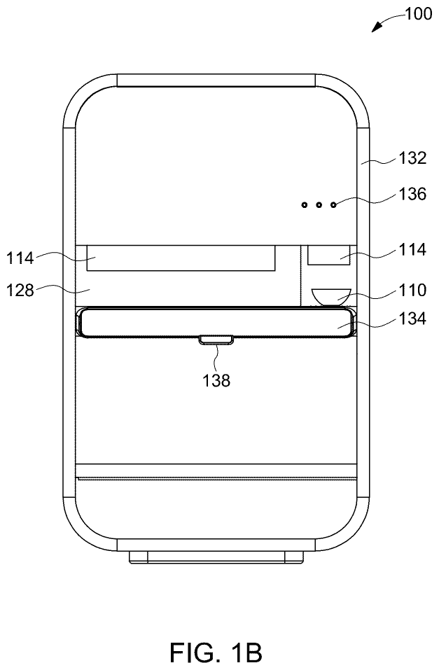

Referring now to FIG. 1A, an internal view of a food cooking and vending device 100 is illustrated, in accordance with some embodiments. The food cooking and vending device 100 may include a dispensing unit 102, a conveyor belt 104, and a control unit 106 (for example, server, processor(s), microcontroller, Very Large-Scale Integration (VLSI), Computer processing unit (CPU), or any other computing device), in accordance with some embodiments of the present disclosure. The dispensing unit 102 may include a bowl dispensing section 108 configured to dispense a bowl 110 from a plurality of bowls (vertically stacked in the bowl dispensing section 108). Additionally, the dispensing unit 102 may include a plurality of raw food material dispensing sections configured to dispense a plurality of raw food materials. The conveyor belt 104 is positioned below the dispensing unit 102. The conveyer belt 104 is configured to move horizontally under the dispensing unit 102. The control unit 106 may execute processor-executable instructions that may cause the food cooking and vending device 100 to cook food and vend a meal selected by a user.

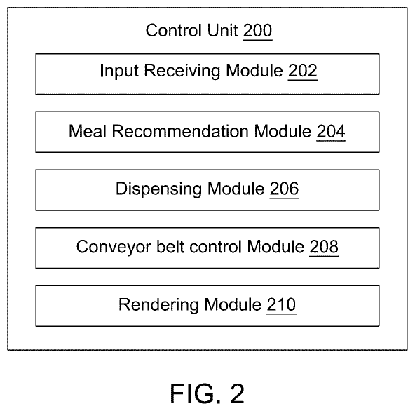

As will be described in greater detail in conjunction with FIGS. 2-6, the control unit 106 may receive a first user input through a User Interface (UI). The first user input may include non-confidential user details. The control unit 106 may further generate one or more meal recommendations from a plurality of meal options based on the first user input using an Artificial Intelligence (AI) model. The control unit 106 may further render the one or more meal recommendations and remaining of the plurality of meal options to the UI. The control unit 106 may further receive a second user input through the UI. The second user input may include a meal selection from the plurality of meal options. The meal selection may require one or more raw food materials from the plurality of raw food materials for meal preparation. The control unit 106 may further cause the bowl dispensing section to dispense the bowl to the conveyor belt to initiate the meal preparation. For each of one or more raw food material dispensing sections corresponding to the one or more raw food materials, the control unit 106 may further cause the conveyor belt to move the bowl to a location under a raw food material dispensing section. The control unit 106 may further cause the conveyor belt to stop under the raw food material dispensing section for a predefined time period. The control unit 106 may further cause the raw food material dispensing section to dispense a raw food material into the bowl.

The conveyor belt 104 may include a belt and two motorized pulleys at opposite ends. The belt may be looped around the two motorized pulleys. The two motorized pulleys may be configured to operate at same speed and spin direction to cause the belt to move around the two motorized pulleys. The belt may be made of a material such as rubber, polyvinylchloride (PVC), polyurethane (PU), metal (e.g., stainless steel), or the like.

In some embodiments, the control unit 106 may include one or more processors (not shown in the figure) and a computer-readable medium (for example, a memory; not shown in the figure). The computer-readable storage medium may store instructions that, when executed by the one or more processors, cause the one or more processors to cook and vend food through the food cooking and vending device, in accordance with aspects of the present disclosure. The computer-readable storage medium may also store various data (for example, user inputs, user details, meal recommendations, food preferences, payment details, humidity level, and the like) that may be captured, processed, and/or required by the food cooking and vending device 100.

The plurality of raw food material dispensing sections of the dispensing unit 102 may include a plurality of detachable containers (for example, a detachable container 112a, a detachable container 112b, a detachable container 112c, or the like) configured to store the plurality of raw food materials. By way of an example, the plurality of detachable containers may be hoppers of different sizes. In some embodiments, the plurality of detachable containers may include a plurality of base material containers and a plurality of topping containers. Each of the plurality of base material containers may include a de-hydrated stackable food block and each of the plurality of topping containers may include one of a food topping or a sauce.

Further, the plurality of raw food material dispensing sections may include a dispensing nozzle unit 114 including a plurality of dispensing nozzles removably attached to the plurality of detachable containers. Each of the plurality of dispensing nozzles may be configured to dispense a predefined quantity of raw food material from an associated detachable container into the bowl 110.

The dispensing unit 102 may further include a lid dispenser 116 configured to dispense a lid on the bowl 110 from a plurality of lids through a lid dispensing nozzle of the dispensing nozzle unit 114. Optionally, the lid dispenser 116 may include an automated lid attaching device to attach the lid to the bowl. In an exemplary embodiment, the plurality of lids may be stacked on top of each other in the lid dispenser 116.

In some embodiments, the dispensing nozzle unit 114 may include at least one sensor mounted in vicinity of each of the plurality of dispensing nozzles. The at least one sensor may be configured to detect presence or absence of the bowl 110 below an associated dispensing nozzle. By way of an example, the at least one sensor may be a proximity sensor, an imaging sensor (e.g., a camera), a photoelectric sensor, an ultrasonic sensor, or the like.

Further, the food cooking and vending device 100 may include a main water tank 118 positioned adjacent to the control unit 106. The main water tank 118 stores water required for meal preparation by the food cooking and vending device 100. The main water tank 118 may be replaceable. The food cooking and vending device 100 may include a hot water tank 120, a connecting pipe 121, and a water heating unit 122 placed in the dispensing unit 102. The water heating unit 122 may heat the water received from the main water tank 118 and transfer the heated water to the hot water tank 120. In an embodiment, one or more of the plurality of dispensing nozzles of the dispensing nozzle unit 114 may be connected to the hot water tank 120 via the connecting pipe 121 to dispense a predefined quantity of hot water from the hot water tank 120 into the bowl 110. In other words, the connecting pipe 121 connects the hot water tank 120 with a nozzle. Hot water is transferred from the hot water tank 120 through the connecting pipe 121 and then dispensed into the bowl 110 through the nozzle.

Further, the food cooking and vending device 100 may include a de-humidifier 124. The de-humidifier 124 may be configured to maintain a predefined level of humidity in the dispensing unit 102. This may prevent the plurality of raw food materials in the plurality of detachable containers from getting microbially contaminated (e.g., through fungal, bacterial, or algal contamination). The food cooking and vending device 100 may include a removeable waste collection tray 126 positioned below the conveyor belt 104 and a cooking area 128 positioned above the conveyor belt 104.

The cooking area 128 may be formed as a chamber between lower surface of the dispensing unit 102 and upper surface of the conveyor belt 104. The cooking area 128 shall not be accessible to the user (i.e., the cooking area 128 may be closed by a window section). However, the cooking area 128 may be visible from outside. The user may view the meal preparation process. In some embodiments, the cooking area 128 may also include a heating means (such as microwave or an induction cooking surface).

In some embodiments, the cooking area 128 may be illuminated by a light source (e.g., Light Emitting Diodes (LEDs)). In an embodiment, the light source may be an Ultraviolet (UV) LED configured to emit light with wavelength in UV range (for example, UV-A (wavelength—315-400 nm), UV-B (wavelength—280-315 nm) and UV-C (wavelength—100-280 nm)). In such an embodiment, the UV LED may be used for sanitizing the cooking area 128. As will be appreciated by those skilled in the art, UV LEDs have an antimicrobial effect and can be used for disinfecting surfaces in a closed chamber. In such an embodiment, the food cooking and vending device 100 may include a disinfection mode which, when activated, may trigger activation of the UV LEDs in the cooking area 128. To ensure user safety, the disinfection mode may only be activated when the cooking area 128 is closed by the window section to prevent any contact of the user with UV light.

Additionally, in some embodiments, the cooking area 128 may include an automatic cleaning means (for example, a wiper, a brush, a liquid spray, or a combination thereof). The automatic cleaning means may be configured to periodically perform a cleaning operation on the upper surface of the conveyor belt 104 after a predefined time interval or after preparing a predefined number of meals.

The cooking area 128 may horizontally span from a first end to a second end. The first end of the cooking area 128 may be under the bowl dispensing section 108 and the second end of the cooking area 128 may be below the lid dispenser 116. The second end may constitute a collection point 130. The collection point 130 may be clearly demarcated from remaining of the cooking area 128. In an embodiment, the collection point 130 may be beyond the conveyor belt 104.

Referring now to FIG. 1B, an external view of the food cooking and vending device 100 is illustrated, in accordance with some embodiments. The food cooking and vending device 100 may include a housing 132 that encloses components of the food cooking and vending device 100 shown in FIG. 1A (such as the dispensing unit 102, the conveyor belt 104, the control unit 106, etc.). The housing 132 may be made of one or more materials. Preferably, side walls and rear wall of the food cooking and vending device 100 are made of galvanized steel. Optionally, the galvanized steel may have a coating of acrylic and polyurethane to improve insulation and stability. The rear wall may include one or more doors to facilitate servicing and maintenance of the food and cooking vending device 100.

Front wall of the food cooking and vending device 100 may be partially made of galvanized steel along with a window section enclosing the cooking area 128. The window section may be open or closed. Preferably, the window section is closed by a transparent or translucent covering material (e.g., glass, polycarbonate, acrylic, polybenzofuran, or the like) at least during meal preparation and when the food cooking and vending device 100 is powered off. When the meal preparation is completed, the covering material of the window section may be controllably lifted (automatically or manually) to allow the user to take the bowl containing the prepared meal from the collection point 130. The lifting may be partial horizontal sliding of the covering material to allow the user to access the collection point 130 and collect the bowl containing the prepared meal. Alternatively, the lifting may be vertical sliding of the covering material or opening outwards using a pneumatic pump attached on both sides of the covering material.

Further, the food cooking and vending device 100 may include a digital display 134 positioned external to the housing 132. The display 134 is configured to present the UI to the user. The display 134 may be a touch screen. The display 134 may also include a built-in scanning device configured to scan a user document to obtain the first user input. The built-in scanning device is also configured to process a payment via digital payments. The housing 132 may include a set of LED indicators 136. The set of LED indicators 136 may be configured to indicate powering on or powering off status of the food cooking and vending device 100 to the user. Alternatively or additionally, the set of LED indicators 136 may be configured to indicate meal preparation status (e.g., “meal preparation pending”, “meal preparation in progress”, “meal preparation completed”, etc.) to the user. For example, the set of LED indicators 136 may include 3 LED indicators. When one of the 3 LED indicators is turned on and remaining of the 3 LED indicators are turned off, the meal preparation status may correspond to “meal preparation pending”. Similarly, when two of the 3 LED indicators are turned on, the meal preparation status may correspond to “meal preparation in progress” and when each of the 3 LED indicators is turned on, the meal preparation status may correspond to “meal preparation completed”. The housing 132 may also include microphone and speaker 138. A microphone may receive user inputs in audio format and a speaker may provide audio output. The microphone and speaker 138 may be positioned in proximity to the display 134. The food cooking and vending device 100 may be configured for voice recognition using speech-to-text conversion techniques.

Referring now to FIG. 2, a functional block diagram of a control unit 200 of an exemplary food cooking and vending device is illustrated, in accordance with some embodiments. In an embodiment, the control unit 200 may be analogous to the control unit 106 of the food cooking and vending device 100. FIG. 2 is explained in conjunction with FIGS. 1A and 1B. The control unit 200 may include a processor communicatively coupled to a memory through a communication bus. The control unit 200 includes, within the memory, an input receiving module 202, a meal recommendation module 204, a dispensing module 206, a conveyor belt control module 208, and a rendering module 210. The modules 202-210 are configured to store processor-executable instructions, which when executed by the processor, may cause the processor to operate the food cooking and vending device 100. A user may be operating the food cooking and vending device 100 at a travel station (such as, but not limited to, an airport, a railway station, a metro station, a bus stop, etc.). By way of an example, the user may be a traveller, a pilot, a flight attendant, a driver, a staff member, etc. The user may provide a user document as an input to the built-in scanning device of the display 134. The user document may be, for example, a flight boarding pass, a train ticket, a bus ticket, a metro ticket, a subway ticket, a ferry ticket, etc. The built-in scanning device may scan the user document to obtain the first user input. The first user input may include non-confidential user details including travel details of the user. The travel details may include, for example, mode of transport, time of departure, time left before departure, duration of travel, user preferences, or the like. The built-in scanning device may be a barcode scanner or a camera. The built-in scanning device may use an Optical Character Recognition (OCR), Computer Vision (CV), Convolutional Neural Network (CNN), or any AI-based technique to scan the user document.

The input receiving module 202 receives the first user input through the UI. The input receiving module 202 transmits the first user input to the meal recommendation module 204. Further, the meal recommendation module 204 generates one or more meal recommendations from a plurality of meal options based on the first user input using an AI model. For example, if the time left before departure for a user is 1 hour, the AI model may provide rice bowl as a meal recommendation. On the other hand, if the time left before departure for the user is 15 minutes, the AI model may provide instant noodles as a meal recommendation. Similarly, if the duration of travel is long, the AI model may provide a meal recommendation that is light and easier to digest.

By way of an example, the AI model may be based on generative AI (e.g., Large Language Models (LLMs)) or deep learning (e.g., CNN, Artificial Neural Network (ANN), etc.). The AI model may generate the one or more meal recommendations through collaborative filtering or content-based approaches. The collaborative filtering may be based on a user-item (i.e., user-meal preferences) interaction matrix. In such cases, training dataset of the AI model may include fewer dimensions. The content-based approaches may be based on a classification model or a regression model, and may use historical data of users to generate the one or more meal recommendations.

Further, the rendering module 210 may render the one or more meal recommendations and remaining of the plurality of meal options to the UI. The UI may include a recommended meals section. Additionally, the UI may present remaining of the plurality of meal options to the user. The user may skip the one or more meal recommendations and opt for one of the remaining of the plurality of meal options. Preferably, the UI presents the recommended meals section before the remaining of the plurality of meal options.

The user may select a meal option from the plurality of meal options (i.e., the one or more meal recommendations and the remaining of the plurality of meal options) and provide a second user input via the UI. The input receiving module 202 may receive the second user input through the UI. The second user input includes a meal selection from the plurality of meal options. The meal selection may require one or more raw food materials from the plurality of raw food materials for meal preparation. The input receiving module 202 may transmit the second user input to the dispensing module 206.

The dispensing module 206 may cause the bowl dispensing section 108 to dispense the bowl 110 to the conveyor belt 104 to initiate the meal preparation. One bowl may be dispensed from a stack of bowls stored in the bowl dispensing section 108. Further, upon dispensing the bowl 110 on the conveyor belt 104, the at least one sensor near the bowl dispensing section 108 may detect the bowl and send an activation signal to the conveyor belt control module 208. Alternatively, a piezoelectric sensor may be installed on the conveyor belt 104. The piezoelectric sensor may detect presence of the bowl 110 on the conveyor belt and send the activation signal to the conveyor belt control module 208.

Upon receiving the activation signal from the at least one sensor or the piezoelectric sensor, the conveyor belt control module 208 may initiate movement of the conveyor belt 104. For each of one or more raw food material dispensing sections corresponding to the one or more raw food materials required for meal preparation, the conveyor belt control module 208 may cause the conveyor belt 104 to move the bowl 110 to a location under a raw food material dispensing section.

Further, the conveyor belt control module 208 may cause the conveyor belt 104 to stop under the raw food material dispensing section for a predefined time period. Further, the at least one sensor associated with the raw food material dispensing section may detect presence of the bowl 110 under the raw food material dispensing section. During this predefined time period, the dispensing module 206 may cause the raw food material dispensing section to dispense a predefined quantity of a raw food material into the bowl 110. This will be repeated until each of the one or more raw food materials are added to the bowl 110. The rendering module 210 may also render a real-time status of the meal preparation on the UI.

Once each of the one or more raw food materials are added to the bowl 110, the conveyor belt 104 may move the bowl 110 towards the collection point 130. Upon reaching the collection point 130, the lid dispenser 116 may dispense the lid on the bowl 110 from a stack of lids. Further, the covering material of the window section may be controllably lifted and the user may collect the bowl 110 containing the prepared meal.

In an embodiment, a user at an airport uses the food cooking and vending device 100. The user may place the boarding pass in front of the in-built scanning device on the display 134. Further, the input receiving module 202 may receive the first input and may provide the first input to the meal recommendation module 204. The meal recommendation module 204 may generate multiple meal recommendations for example—rice, noodles, and oats—based on the first user and availability of raw food materials. The rendering module 210 may present the three meal recommendations on the UI. The user may then provide a second user input (i.e., meal selection) to the food cooking and vending device 100. The meal recommendation module 204 may provide additional options corresponding to the meal selection on the UI. For example, if the user selected noodles, the UI may ask the user for toppings and sauces/honey. So, the second user input comprises the meal selection as well as toppings and sauces/honey selection by the user.

For example, the meal selection of the user is noodles, the toppings selection is capsicum and chicken, and the sauces selection is chilli garlic sauce. Now, the dispensing module 206 and the conveyor belt control module 208 initiate the meal preparation. The dispensing module 206 causes the bowl dispensing section 108 to dispense the bowl 110 to the conveyor belt 104. The conveyor belt control module 208 causes the conveyor belt 104 to move the bowl 110 to a location under a noodles dispensing section. Upon reaching the location, the conveyor belt control module 208 causes the conveyor belt 104 to stop under the noodles dispensing section for a predefined time period. The noodles dispensing section may include a hopper containing dehydrated stackable food block of noodles. Then, the dispensing module 206 causes the noodles dispensing section to dispense a predefined quantity of noodles into the bowl 110. The predefined quantity of noodles may be in form of a dehydrated stackable food block. The conveyor belt control module 208 then causes the conveyor belt 104 to move the bowl 110 to a location under a hot water dispensing section. The predefined quantity of noodles is hydrated with hot water. In an embodiment, the conveyor belt control module 208 then causes the conveyor belt 104 to stop under the hot water dispensing section for a predefined time period to allow the noodles to hydrate properly. Similarly, the process will be repeated for the toppings selection and the sauces selection. Once the meal preparation is complete, the bowl 110 is transferred to the collection point 130 where a lid is dispensed upon the bowl 110 and the user is allowed to collect the bowl.

It should be noted that all such aforementioned modules 202-210 may be represented as a single module or a combination of different modules. Further, as will be appreciated by those skilled in the art, each of the modules 202-210 may reside, in whole or in parts, on one device or multiple devices in communication with each other. In some embodiments, each of the modules 202-210 may be implemented as dedicated hardware circuit comprising custom application-specific integrated circuit (ASIC) or gate arrays, off-the-shelf semiconductors such as logic chips, transistors, or other discrete components. Each of the modules 202-210 may also be implemented in a programmable hardware device such as a field programmable gate array (FPGA), programmable array logic, programmable logic device, and so forth. Alternatively, each of the modules 202-210 may be implemented in software for execution by various types of processors (e.g., processor). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for method of cooking and vending food through a food cooking and vending device. For example, the food cooking and vending device 100 and the associated control unit 106 may cook and vend food by the processes discussed herein. In particular, as will be appreciated by those of ordinary skill in the art, control logic and/or automated routines for performing the techniques and steps described herein may be implemented by the device 100 and the associated control unit 106 either by hardware, software, or combinations of hardware and software. For example, suitable code may be accessed and executed by the one or more processors on the device 100 to perform some or all of the techniques described herein. Similarly, application specific integrated circuits (ASICs) configured to perform some, or all of the processes described herein may be included in the one or more processors on the device 100.

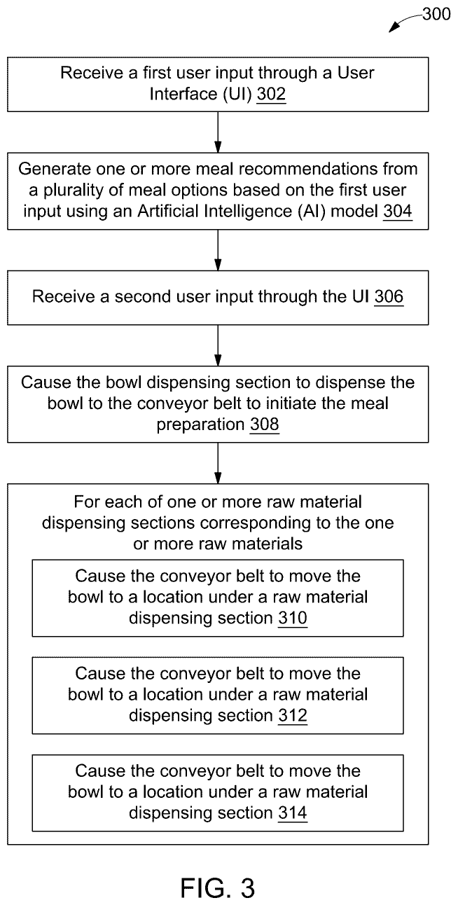

Referring now to FIG. 3, an exemplary process 300 of a method of food cooking and vending is depicted via a flowchart, in accordance with some embodiments. FIG. 3 is explained in conjunction with FIGS. 1A, 1B, and 2. In an embodiment, the process 300 may be implemented by the food cooking and vending device 100. The process 300 may include scanning, by the built-in scanning device of the display 134, a user document to obtain the first user input. In some embodiments, the process 300 may also include processing a payment via digital payments by the built-in scanning device. Further, at step 302, a first user input is received through a UI by the input receiving module 202. The first user input includes non-confidential user details (such as, but not limited to, boarding time, time remaining in departure, order history, user preferences, etc.).

At step 304, one or more meal recommendations are generated from a plurality of meal options based on the first user input using an AI model by the meal recommendation module 204.

At step 306, the one or more meal recommendations and remaining of the plurality of meal options are rendered to the UI by the rendering module 210. Additionally, customization options for the meals may also be rendered to the UI once the user selection one of the plurality of meal options. The customization options may include toppings or sauces to be added for a specific order. In some embodiments, the user may also be allowed to specify quantities of various raw food materials through the UI and/or provide additional instructions (e.g., “make the meal less spicy”, “do not overheat the meal”, etc.) through the UI or through the microphone in an audio format. The food cooking and vending device 100 may be configured for voice recognition using speech-to-text conversion techniques.

At step 308, a second user input is received through the UI. The second user input includes a meal selection from the plurality of meal options. Additionally, the second user input may include toppings selection and sauces/honey selection provided by the user. The meal selection requires one or more raw food materials from a plurality of raw food materials for meal preparation.

At step 310, the dispensing module 206 may cause the bowl dispensing section 108 to dispense the bowl 110 to the conveyor belt 104 to initiate the meal preparation. It should be noted that the bowl dispensing section 108 includes a plurality of bowls stacked on top of each other and dispenses one bowl for each order (here, the dispensed bowl is the bowl 110).

Further, for each of one or more raw food material dispensing sections corresponding to the one or more raw food materials, at step 312, the conveyor belt control module 208 causes the conveyor belt 104 to move the bowl 110 to a location under a raw food material dispensing section.

The plurality of raw food material dispensing sections includes a plurality of detachable containers (e.g., the container 112a, the container 112b, and the container 112c) configured to store the plurality of raw food materials. In some embodiments, the plurality of detachable containers includes a plurality of base material containers, a plurality of topping containers, and at least one hot water tank. Each of the plurality of base material containers includes a dehydrated stackable food block and each of the plurality of topping containers includes one of a food topping or a sauce. In an embodiment, the plurality of detachable containers may be hoppers of various sizes and volumes.

The plurality of raw food material dispensing sections further includes a dispensing nozzle unit including a plurality of dispensing nozzles removably attached to the plurality of detachable containers. Each of the plurality of dispensing nozzles is configured to dispense a predefined quantity of raw food material from an associated detachable container into the bowl 110.

At step 314, the conveyor belt control module 208 causes the conveyor belt 104 to stop under the raw food material dispensing section for a predefined time period. Further, at step 316, the dispensing module 206 causes the raw food material dispensing section to dispense a raw food material into the bowl 110. In some embodiments, the process 300 may include maintaining, by the de-humidifier 124, a pre-defined level of humidity in the dispensing unit 102.

The steps 312-316 may be repeated until each of the one or more raw food materials required for the meal preparation are added. Once the meal preparation is completed, the conveyor belt control module 208 causes the conveyor belt 104 to move the bowl 110 to the collection point 130. The lid dispenser 116 may dispense a lid from a stack of a plurality of lids on the bowl 110. Further, the user may pick up the prepared meal from the collection point 130.

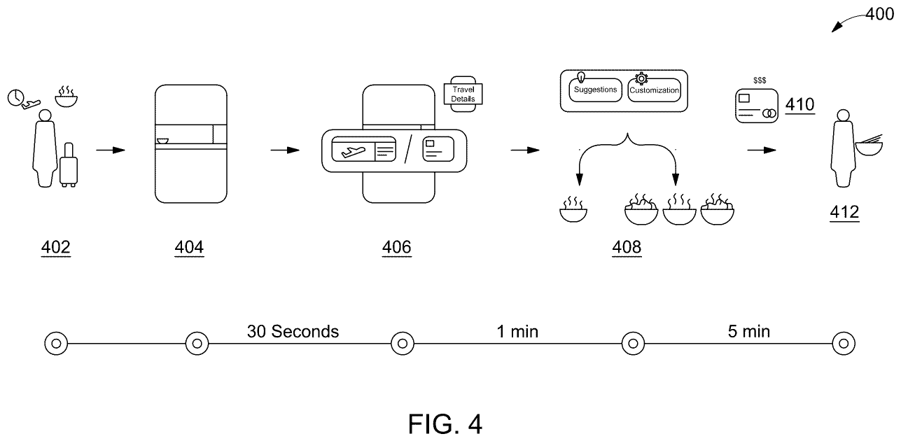

Referring now to FIG. 4, an exemplary method 400 of generating meal recommendations by a food cooking and vending device is depicted, in accordance with some embodiments. FIG. 4 is explained in conjunction with FIGS. 1A, 1B, 2, and 3. The method 400 may be implemented by the food cooking and vending device 100.

In an exemplary scenario, a user 402 may access a food cooking and vending device 404 (analogous to the food cooking and vending device 100) at an airport. Further, at step 406, the user 402 may scan a boarding pass or a ticket via the built-in scanning device of the display 134. The built-in scanning device is configured to scan the boarding pass, ticket, or payment cards and coupons. Upon scanning the boarding pass or the ticket, the input receiving module 202 receives a first user input. The first user input includes non-confidential user details, such as boarding time, time remaining in boarding the flight, user food preferences, or recent orders, if any.

Further, at step 408, the meal recommendation module 204 generates at least one meal recommendation for the user 402 based on the first user input, and the rendering module 210 renders the one or more meal recommendations to the UI. The meal recommendations are generated within less than one minute of the user 402 scanning the boarding pass. Further, the user 402 can provide a meal selection from the one or more meal recommendations or from remaining of the plurality of meal options (direct preference) through the UI. The meal selection of the user 402 is received by the input receiving module 202 as a second user input. The second user input may also include a customization of toppings or sauces.

At step 410, the user 402 may process the payment through the UI. The built-in scanning device may be configured to scan payment card details of the user 402 for ease of payment process. Further, at step 412, the prepared meal is provided to the user 402 by the food cooking and vending device 404. The meal may be prepared within less than 5 minutes of receiving the second user input.

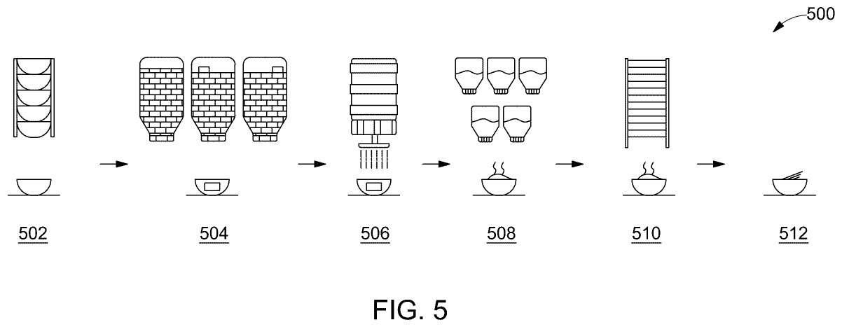

Referring now to FIG. 5, an exemplary method 500 of meal preparation by the food cooking and vending device 100 is illustrated, in accordance with some embodiments. FIG. 5 is explained in conjunction with FIGS. 1A, 1B, 2, 3, and 4.

At step 502, the dispensing module 206 dispenses the bowl 110 from the bowl dispensing section 108 on a conveyor belt 104 in the cooking area 128. The bowl dispensing section 108 dispenses one bowl for each order.

Further, at step 504, upon dispensing the bowl 110, the conveyor belt control module 208 may cause the conveyor belt 104 to move the bowl 110 under a first raw food material dispensing section corresponding to a first raw food material required for meal preparation. By way of an example, the first raw food material may be a base material (i.e., a de-hydrated stackable food block). When the bowl 110 reaches under the first raw food material dispensing section, the conveyor belt control module 208 causes the conveyor belt 104 to stop and the dispensing module 206 dispenses a predefined quantity of the first raw food material required for meal preparation.

Further, at step 506, upon adding the first raw food material to the bowl 110, the conveyor belt control module 208 may cause the conveyor belt 104 to move the bowl 110 under a second raw food material dispensing section corresponding to a second raw food material required for meal preparation. By way of an example, the second raw food material may be hot water. The dispensing nozzle for dispensing hot water may be a shower head. Hot water is added such that the dehydrated stackable food block is hydrated uniformly. When the bowl 110 reaches under the second raw food material dispensing section, the conveyor belt control module 208 causes the conveyor belt 104 to stop and the dispensing module 206 dispenses a predefined quantity of the second raw food material required for meal preparation.

Further, at step 508, upon adding the second raw food material to the bowl 110, the conveyor belt control module 208 may cause the conveyor belt 104 to move the bowl 110 under a third raw food material dispensing section corresponding to a third raw food material required for meal preparation. By way of an example, the third raw food material may be toppings or sauces selected by the user. When the bowl 110 reaches under the third raw food material dispensing section, the conveyor belt control module 208 causes the conveyor belt 104 to stop and the dispensing module 206 dispenses a predefined quantity of the third raw food material required for meal preparation.

Further, at step 510, when all the required raw food materials have been added to the bowl, the dispensing module 206 may dispense a lid from a stack of a plurality of lids on the bowl 110.

At step 512, the bowl 110 containing the prepared meal covered with lid is placed at the collection 130 for the user to pick up.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

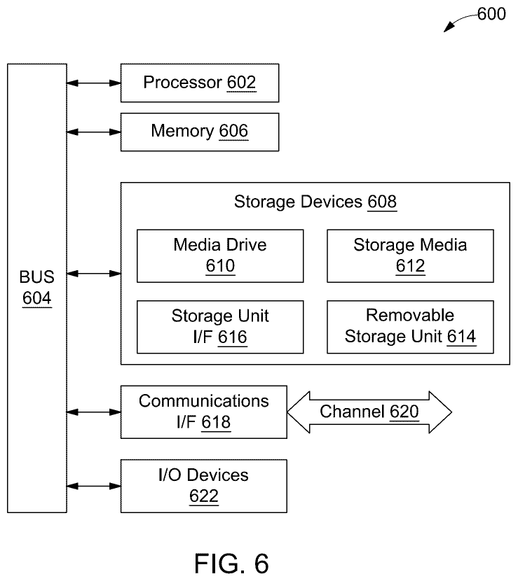

The disclosed methods and systems may be implemented on a conventional or a general-purpose computer system, such as a personal computer (PC) or server computer. Referring now to FIG. 6, an exemplary computing system 600 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 600 may represent, for example, a user device such as a desktop, a laptop, a mobile phone, personal entertainment device, DVR, and so on, or any other type of special or general-purpose computing device as may be desirable or appropriate for a given application or environment. The computing system 600 may include one or more processors, such as a processor 602 that may be implemented using a general or special purpose processing engine such as, for example, a microprocessor, microcontroller or other control logic. In this example, the processor 602 is connected to a bus 604 or other communication medium. In some embodiments, the processor 602 may be an Artificial Intelligence (AI) processor, which may be implemented as a Tensor Processing Unit (TPU), or a graphical processor unit, or a custom programmable solution Field-Programmable Gate Array (FPGA).

The computing system 600 may also include a memory 606 (main memory), for example, Random Access Memory (RAM) or other dynamic memory, for storing information and instructions to be executed by the processor 602. The memory 606 also may be used for storing temporary variables or other intermediate information during execution of instructions to be executed by the processor 602. The computing system 600 may likewise include a read only memory (“ROM”) or other static storage device coupled to bus 604 for storing static information and instructions for the processor 602.

The computing system 600 may also include a storage device 608, which may include, for example, a media drive 610 and a removable storage interface. The media drive 610 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 612 may include, for example, a hard disk, magnetic tape, flash drive, or other fixed or removable medium that is read by and written to by the media drive 610. As these examples illustrate, the storage media 612 may include a computer-readable storage medium having stored therein particular computer software or data.

In alternative embodiments, the storage devices 608 may include other similar instrumentalities for allowing computer programs or other instructions or data to be loaded into the computing system 600. Such instrumentalities may include, for example, a removable storage unit 614 and a storage unit interface 616, such as a program cartridge and cartridge interface, a removable memory (for example, a flash memory or other removable memory module) and memory slot, and other removable storage units and interfaces that allow software and data to be transferred from the removable storage unit 614 to the computing system 600.

The computing system 600 may also include a communications interface 618. The communications interface 618 may be used to allow software and data to be transferred between the computing system 600 and external devices. Examples of the communications interface 618 may include a network interface (such as an Ethernet or other NIC card), a communications port (such as for example, a USB port, a micro USB port), Near field Communication (NFC), etc. Software and data transferred via the communications interface 618 are in the form of signals which may be electronic, electromagnetic, optical, or other signals capable of being received by the communications interface 618. These signals are provided to the communications interface 618 via a channel 620. The channel 620 may carry signals and may be implemented using a wireless medium, wire or cable, fiber optics, or other communications medium. Some examples of the channel 620 may include a phone line, a cellular phone link, an RF link, a Bluetooth link, a network interface, a local or wide area network, and other communications channels.

The computing system 600 may further include Input/Output (I/O) devices 622. Examples may include, but are not limited to a display, keypad, microphone, audio speakers, vibrating motor, LED lights, etc. The I/O devices 622 may receive input from a user and also display an output of the computation performed by the processor 602. In this document, the terms “computer program product” and “computer-readable medium” may be used generally to refer to media such as, for example, the memory 606, the storage devices 608, the removable storage unit 614, or signal(s) on the channel 620. These and other forms of computer-readable media may be involved in providing one or more sequences of one or more instructions to the processor 602 for execution. Such instructions, generally referred to as “computer program code” (which may be grouped in the form of computer programs or other groupings), when executed, enable the computing system 600 to perform features or functions of embodiments of the present invention.

In an embodiment where the elements are implemented using software, the software may be stored in a computer-readable medium and loaded into the computing system 600 using, for example, the removable storage unit 614, the media drive 610 or the communications interface 618. The control logic (in this example, software instructions or computer program code), when executed by the processor 602, causes the processor 602 to perform the functions of the invention as described herein.

Thus, the disclosed method and device try to overcome the technical problem of cooking and vending the food in real-time in an efficient and hygienic way. The method and device provide means to cook food in real-time in front of the user and vends it to the user with minimal human effort. Further, the method and device offers a transparent window to allow users to engage with the cooking experience. Further, the method and device may dispense the plurality of base material and toppings and sauces to cook the food with hot water. Further, the method and device offers a plurality of detachable containers for easy refill and washing. The device also offers an interactive screen with in-built scanner, gives a dynamic ordering experience to the user. Further, the device includes a built in Voice recognition feature to allow users contactless interactions. The device also offers food customization between rice, noodles, and oats and select toppings according to their taste. Further, the device offers a built-in scanner in the touch screen display to scan items such as boarding passes, tickets (bus/train/metro/subway/ferry/etc.), coupons and payment cards (credit/debit/prepaid/gift/travel cards) in order to ascertain the travel details of the customer or user.

As will be appreciated by those skilled in the art, the techniques described in the various embodiments discussed above are not routine, or conventional, or well understood in the art. The techniques discussed above provide for cooking food in real-time. The techniques first receive a first user input through a User Interface (UI). The first user input includes non-confidential user details. The techniques then generate one or more meal recommendations from a plurality of meal options based on the first user input using an Artificial Intelligence (AI) model. Further, the techniques receive a second user input through the UI. The second user input includes a meal selection from the plurality of meal options. The meal selection requires one or more raw food materials from a plurality of raw food materials for meal preparation. The techniques then cause the bowl dispensing section to dispense the bowl to the conveyor belt to initiate the meal preparation. Further, for each of one or more raw food material dispensing sections corresponding to the one or more raw food materials, the techniques cause the conveyor belt to move the bowl to a location under a raw food material dispensing section. Further, the techniques cause the conveyor belt to stop under the raw food material dispensing section for predefined time period. The techniques then cause the raw food material dispensing section to dispense a raw food material into the bowl.

In light of the above mentioned advantages and the technical advancements provided by the disclosed method and device, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described device and method of working of a food cooking and vending device. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

I/we claim:

1. A food cooking and vending device, comprising:
a dispensing unit comprising:
a bowl dispensing section configured to dispense a bowl from a plurality of bowls; and
a plurality of raw food material dispensing sections configured to dispense a plurality of raw food materials;
a conveyor belt positioned below the dispensing unit, wherein the conveyer belt is configured to move horizontally under the dispensing unit; and
a control unit configured to:
receive a first user input through a User Interface (UI), wherein the first user input comprises non-confidential user details;
generate one or more meal recommendations from a plurality of meal options based on the first user input using an Artificial Intelligence (AI) model;
render the one or more meal recommendations and remaining of the plurality of meal options to the UI;
receive a second user input through the UI, wherein the second user input comprises a meal selection from the plurality of meal options, and wherein the meal selection requires one or more raw food materials from the plurality of raw food materials for meal preparation;
cause the bowl dispensing section to dispense the bowl to the conveyor belt to initiate the meal preparation; and
for each of one or more raw food material dispensing sections corresponding to the one or more raw food materials,
cause the conveyor belt to move the bowl to a location under a raw food material dispensing section;
cause the conveyor belt to stop under the raw food material dispensing section for a predefined time period; and
cause the raw food material dispensing section to dispense a raw food material into the bowl.

2. The food cooking and vending device as claimed in claim 1, wherein the plurality of raw food material dispensing sections comprises:
a plurality of detachable containers configured to store the plurality of raw food materials; and
a dispensing nozzle unit comprising a plurality of dispensing nozzles removably attached to the plurality of detachable containers, wherein each of the plurality of dispensing nozzles is configured to dispense a predefined quantity of raw food material from an associated detachable container into the bowl.

3. The food cooking and vending device as claimed in claim 2, wherein the plurality of detachable containers comprises a plurality of base material containers, a plurality of topping containers, and at least one hot water tank, and wherein each of the plurality of base material containers comprises a de-hydrated stackable food block and each of the plurality of topping containers comprises one of a food topping or a sauce.

4. The food cooking and vending device as claimed in claim 1, wherein the dispensing unit further comprises a lid dispenser configured to dispense a lid on the bowl from a plurality of lids.

5. The food cooking and vending device as claimed in claim 1, further comprising a housing enclosing the dispensing unit, the conveyor belt, and the control unit.

6. The food cooking and vending device as claimed in claim 5, further comprising a digital display positioned external to the housing, wherein the display is configured to present the UI.

7. The food cooking and vending device as claimed in claim 6, wherein the digital display comprises a built-in scanning device configured to scan a user document to obtain the first user input, wherein the control unit is further configured to extract the non-confidential user details from the user document.

8. The food cooking and vending device as claimed in claim 1, wherein the dispensing unit further comprises a de-humidifier configured to maintain a pre-defined level of humidity in the dispensing unit.

9. The food cooking and vending device as claimed in claim 1, wherein the dispensing unit further comprises:
a main water tank; and
a water heating unit configured to:
receive water from the main water tank; and
heat the water to a predefined temperature.

10. A method of food cooking and vending, the method comprising:
receiving, by a control unit, a first user input through a User Interface (UI), wherein the first user input comprises non-confidential user details;
generating, by the control unit, one or more meal recommendations from a plurality of meal options based on the first user input using an Artificial Intelligence (AI) model;
rendering, by the control unit, the one or more meal recommendations and remaining of the plurality of meal options to the UI;
receiving, by the control unit, a second user input through the UI, wherein the second user input comprises a meal selection from the plurality of meal options, and wherein the meal selection requires one or more raw food materials from a plurality of raw food materials for meal preparation;
causing, by the control unit, a bowl dispensing section to dispense a bowl to a conveyor belt to initiate the meal preparation, wherein:
a dispensing unit comprises the bowl dispensing section and a plurality of raw food material dispensing sections,
the bowl dispensing section is configured to dispense the bowl from a plurality of bowls,
a plurality of raw food material dispensing sections is configured to dispense the plurality of raw food materials,
a conveyor belt is positioned below the dispensing unit, and
the conveyer belt is configured to move horizontally under the dispensing unit; and
for each of one or more raw food material dispensing sections corresponding to the one or more raw food materials,
causing, by the control unit, the conveyor belt to move the bowl to a location under a raw food material dispensing section;
causing, by the control unit, the conveyor belt to stop under the raw food material dispensing section for a predefined time period; and
causing, by the control unit, the raw food material dispensing section to dispense a raw food material into the bowl.

11. The method as claimed in claim 10, wherein the plurality of raw food material dispensing sections comprises:
a plurality of detachable containers configured to store the plurality of raw food materials; and
a dispensing nozzle unit comprising a plurality of dispensing nozzles removably attached to the plurality of detachable containers, wherein each of the plurality of dispensing nozzles is configured to dispense a predefined quantity of raw food material from an associated detachable container into the bowl.

12. The method as claimed in claim 11, wherein the plurality of detachable containers comprises a plurality of base material containers, a plurality of topping containers, and at least one hot water tank, and wherein each of the plurality of base material containers comprises a de-hydrated stackable food block and each of the plurality of topping containers comprises one of a food topping or a sauce.

13. The method as claimed in claim 10, wherein the dispensing unit further comprises a lid dispenser configured to dispense a lid on the bowl from a plurality of lids.

14. The method as claimed in claim 10, wherein the dispensing unit, the conveyor belt, and the control unit are enclosed within a housing.

15. The method as claimed in claim 14, further comprising presenting, by a digital display, the UI, wherein the digital display is positioned external to the housing.

16. The method as claimed in claim 15, further comprising:
scanning, by a built-in scanning device of the display, a user document to obtain the first user input; and
extracting, by the control unit, the non-confidential user details from the user document.

17. The method as claimed in claim 10, further comprising maintaining, by a de-humidifier in the dispensing unit, a pre-defined level of humidity in the dispensing unit.

18. The method as claimed in claim 10, further comprising:
receiving, by a water heating unit in the dispensing unit, water from a main water tank; and
heating, by the heating unit, the water to a predefined temperature.
